(19) United States
(12) Patent Application Publication
(10) Pub. No.: US 2006/0291216 A1
(43) Pub. Date: Dec. 28, 2006

(54) Apparatus for reducing in size an igniter circuit and assembly

(76) Inventors: Daniel M. Blumel, Ogden, UT (US); Tung-Hsin Lin, Tao-Yuan City (TW)

Correspondence Address: KIRTON AND MCCONKIE, 60 EAST SOUTH TEMPLE,, SUITE 1800, SALT LAKE CITY, UT, 84111, US

(21) Appl. No.: 11/151,768

(22) Filed: Jun. 14, 2005

(51) Int. Cl. F21V 15/00

(52) U.S. Cl. 362/362

(57) ABSTRACT

The present invention converts a D2 burner to a D1S bulb by reducing the size of the transformer and providing springs to couple the arc tube to the igniter, potting the circuitry, and evacuating the air from the circuitry. A spring may be used to couple the burner to the igniter.

### BACKGROUND

1. Field of the Invention

The present application relates to a method and apparatus for converting D2 bulbs to D1S bulbs. Particularly, this invention relates to utilizing a standard D2 bulb for making standard D1S bulbs for automotive, industrial, aviation, and other applications

2. Background of the Invention and Related Art

There currently exists a number of different high-intensity discharge lamps (“HID”) which are used in applications including automobile headlights. HID lamps create several benefits not found in standard halogen lights, including increased visibility, as well as improved safety conditions. These benefits are derived from the use of different halide metals and gasses within a standard HID bulb. HID bulbs are incorporated in many applications, especially where night time vision is critical. However, attempts to broaden the use of HID bulbs have met with several technical difficulties because such bulbs require high voltage and complex starting (igniter) and control circuitry (ballasts). To overcome these technical challenges, the prior art teaches the use of a toroid transformer, which is capable of producing between ten thousand and thirty thousand volts, the amount necessary to start the HID lamp. Also, taught by the prior art are a series of plastic walls within the base of the bulb to create barriers to arcing within the bulb, thus reducing the potential for internal arcing caused by the high voltage.

While these solutions allow the HID to be used in some applications such as car lights, there are still other applications which present problems that are not addressed by the above-mentioned prior art. For example, use of the prior art bulbs results in arcing inside the bulb base when starting at high altitude, especially during hot re-strike. This arcing can destroy the circuitry. Similarly, the prior art fails to address the energy requirements of a pulsating HID light. For example, when the light pulsates, the energy requirements increase dramatically. This drastic increase in energy requirements generates excess heat which also contributes to circuitry failure. Finally, the prior art fails to teach an apparatus or method which allows a user to convert a D2 arc tube with P32d base to a D1S bulb. This is desirable because of the cost savings which would result from using standard, off-the-shelf D2 bulbs. The size difference between these two bulbs has prevented small companies from entering the D1S size bulb market because larger producers are required to produce their own light bulbs (arc tubes) to fit into the D1S bulb size.

The present invention seeks to address the shortcomings of the prior art.

### SUMMARY

The present invention is an apparatus for mounting standard, off-the-shelf D2 bulbs in D1S bulb fittings. As taught by the present invention, a user takes a D2 bulb and couples to a D1S bulb-sized circuit board having two contact leads fastened thereto. The contact leads may be springs as taught by the present invention, thus the spring can be configured to couple with a P32d-sized base. The circuit board is placed inside a housing, and the burner or arc tube is inserted through a hole in the housing engaging the contact springs. Finally, an outer plastic cover is placed over the burner igniter circuit board and then a metal shield igniter cover assembly is installed on the outside surrounding the entire igniter assembly. The entire burner/circuit board assembly, also known as the igniter, plus the arc tube constitutes a D1S bulb.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawing. Understanding that the drawing depict only typical embodiments of the present invention and are not, therefore, to be considered as limiting the scope of the invention, the present invention will be described and explained with additional specificity and detail through the use of the accompanying drawing in which:

FIG. 1 illustrates an exploded view of the present invention.

### DETAILED DESCRIPTION OF THE PREFERRED EMBODIMENTS

It will be readily understood that the components of the present invention, as generally described and illustrated in the figure herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

The term burner is a burner or arc tube.

The term bulb comprises a burner and an igniter.

The term D2 is a standard size burner commonly known in the art having a P32d size base.

The term D1S is a standard bulb size commonly known in the art.

The term igniter assembly refers to a circuit board and the component parts used in starting the high voltage arc within an HID burner.

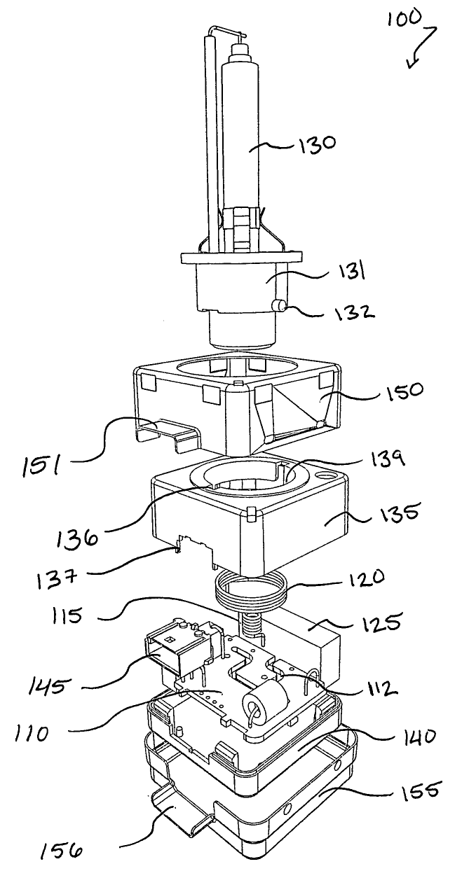

As illustrated in FIG. 1, the lamp 100 in the present invention comprises generally an arc tube 130, an upper shield 150, an upper housing 135, a return spring 120, a transformer 125, an igniter assembly or circuit board 110, a lower housing 140, and a lower shield 155. When fitted together, upper housing 135 and lower housing 140 encase circuit board 110, input spring 115, return spring 120 and transformer 125. Upper shield 150 and lower shield 155 further encase housings 135 and 140. Bulb base 131 is coupled to spring 120 when disposed in apertures in upper shield 150 and upper housing 135.

FIG. 1 illustrates an exemplary embodiment of the present invention. There is a circuit board 110 with a slit cut 112 through a portion of the circuit board 110. The slit 112 promotes electrical isolation of power input spring 115, thus preventing arcing. Slit 112 further promotes electrical isolation on circuit board 110, once potting material is added (see below). The use of the componentry on the circuit board 110 is typical for an igniter of an HID. Connected to the circuit board 110 are both power input spring 115 and the power return spring 120. Springs 115 and 120 are expandable. The springs, as taught by the present invention, are configured to receive and/or releasable couple with a standard P32d sized base 131 of an arc tube 130.

Also, as taught by the present invention, the input spring 115 and return spring 120 are can act in either a power input or power return, as is commonly known in the art of alternating current circuitry.

Also coupled to circuit board 110 is an ultra thin film insulated transformer 125. The transformer 125 is made of MEXCEL brand wire, purchased from Mitsubishi, using the M.E.D.I.S. wire insulation deposition process. For an example of such wire using this process, see U.S. Pat. No. 4,576,694 to Jidai. By utilizing this very thin wire and insulation system, the present invention teaches the ability to significantly reduce the size and/or space needed for a D1S-sized high voltage transformer while having a P32d-sized base 131 coupled thereto, thus allowing the integration of a P32d base and high voltage transformer to be integrated into a D1S-sized igniter housing. Base 131 is also configured with a fitting tab 132, so as to ensure the proper locking of the arc tube 130 with the housing 135 in hole 139. Due to the increased efficiency of the present invention's igniter circuit and associated reduced heat generation, a variety of bulb wattages can be used with the same circuit board. The present invention is compatible with at least a 35, 50 and 70 watt burners. As a result, the present invention can accept any off-the-shelf brand D2 burner with a P32d base, and convert it to a D1S bulb.

To configure the present invention, the base 131 of the arc tube 130 is disposed in a hole 139 in the upper housing 135 and positioned adjacent to a return spring 120. Return spring 120 is expandable to receive corresponding return structure of base 131 for positive, press-fit contact. Return spring 120 is permitted to float or move so as to receive base 131, yet accurately position the spring 120 to the correct connection on circuit board 110. The structural walls of the housing also function to retain the spring in its proper relative location. To further aid in the alignment of base 131 and spring 120, an alignment slot 136 is disposed on the inner rim of the hole 139 of the upper housing 135, through which the fitting tab 132 is guided.

Also molded into the upper housing 135, is a connector slot 137 so as to allow connector fitting 145 to pass there through. Connector fitting 145 is configured to receive a power supply for the igniter. Lower housing 140 is coupled to the upper housing 135 to create a completely enclosed circuitry having the arc tube coupled thereto.

Upper shield 150 is coupled to lower shield 155. The upper shield 150 and lower shield 155 each have a connector shroud 151 and 156, respectively, through which connector fitting 145 passes.

As taught herein, the transformer may provide a turns ratio of 2:150 or 3:150 for generating up to 30,000+ volts. The turn ratio of transformer 125 is for generating up to 30,000 volts. Additionally, the lamp cold start up current may be as high as 3 Amperes RMS. Thus the copper coil size can be AWG#28 or 0.322 mm diameter to sustain the high current. The present invention solves the problem of how to wind the necessary heavy gauge coil windings into a small size high voltage transformer to facilitate the operation and structure of an off-the-shelf D2 burner into a D1S bulb.

The ferrite material core of ignition high voltage transformer is zinc nickel sinter powder. The novel configuration of the transformer 125 of the present invention, includes the rectangular shaped ferrite core with the wire wrapped around the same rectangular form, this minimizes the space occupied by the transformer. The transformer 125 is placed adjacent the circuit board 110, so as to allow the circuit board 110 to sit above the housing 140. The transformer 125 however, is sufficiently spaced away from the housing wall 135 and 140 for high voltage isolation so that the potting can fill the 1 mm space. This prevents arcing from the high voltage generated by transformer 125 to the outer metal shield 150 and 155 which are typically grounded. The transformer's 125 coil winding shape is a parallelogram or preferably rectangular (to save space), so there is no core saturation when the high igniting pulse current goes through the core. The corners of the ferrite core are curved sufficiently as to not damage the wire during winding. The prior art uses a toroid core, which needs to have a gap to prevent saturation during the igniting stage. However, the toroid shape of the winding used in the prior art also can create an acoustic resonate noise when high start up current passes through the core. In contrast, the present invention teaches an open rectangular core, thus eliminating the noise associated with the prior art.

Also because the present invention teaches a flat rectangular shaped core, no magnetic field close loop is created, and thus no acoustic resonance sound created. Furthermore, the rectangular shaped core and windings of the present invention permit configuration of the transformer in a substantially smaller space.

The present invention further teaches using laminated 0.15 T×0.65 H wire having conductor resistance of 0.18 ohm/m. This reduces copper loss in the copper coil as compared to traditional round shaped copper coil wire. In addition, by stacking the flat wire winding there is no skin effect like that created when using round copper coil wire.

As taught by the present invention, the two or three wraps are wrapped with the wire lying broad side down so as to minimize the profile size of the transformer. However, the one hundred fifty wraps are wrapped so as the narrower side of the wire is pressed up against the transformer core. The present invention teaches one advantage of wrapping the wire in this manner thereby allowing the maximum number of wraps, and also to maximize the increase in voltage as allowed by the size and shape of the transformer.

Once the invention is completely assembled, a potting material is placed inside the housing to completely fill any void area therein. The devices are then placed in an evacuation chamber while the potting material remains fluid to remove substantially all of the air or air bubbles formed in the potting material, by drawing them to the surface. In this way, the present invention teaches substantially evacuating all the air from the igniter circuitry cavity. An epoxy resin may be used as a potting material because it is fluid and avoids the air bubbles or pin holes often associated with other potting materials after being placed in a vacuum.

The evacuation of the housing also increases the range of pressure conditions under which the present invention can operate. For example, the potting material increases the range of altitude at which the present invention can operate. Indeed the present invention teaches reliable high altitude cold starting and hot-restrike capability in reduced atmospheric pressure down to 1.05 PSIA (0.0714 ATM) or 7.14% of normal atmospheric pressure as a result of the core transformer configurations and the potting material used. Not only does the use of an evacuation chamber during the potting process eliminate the air bubbles within the igniter housing, this process due to the removal of air from the potting compound eliminates possible sparking inside the circuitry housing during operation. Thus allowing the present invention to be used in aviation to over 60,000 feet, the potting material also acts as a heat sink, drawing heat away from the circuitry. This increases the longevity of the circuitry components, and also increases the tolerance of the igniter to heat and vibration. In addition, the potting material reduces a fire hazard from internal igniter arcing which could occur if flammable or explosive material is in the air.

Due to the unique structure and function of the igniter of the present invention, it is also robust enough for continuous sustained restriking for continuous “pulsing” (On/Off) operation from 2 Hz rate down to ½ Hz pulsing rate. The increased efficiency of the igniter, along with the heat sink (potting), the present invention can be used as landing lights, or flashing lights, especially in use with aircraft, emergency vehicles, and in outer space for docking spacecraft or satellite.

Another feature of the present invention for aeronautical application is the reduced weight of the present invention, with the present invention weighing 5% to 10% less than similar devices presently known in the art.

What is claimed:

1. A lamp apparatus comprising a standard D2 burner integrated into a D1S bulb: assembly.

2. The apparatus of claim 1 wherein the D2 burner is coupled to the D1S bulb assembly by an expandable power input spring.

3. The apparatus of claim 1 wherein the D2 burner is coupled to the D1S bulb assembly by an expandable power return spring.

4. The apparatus of claim 1 further comprising an ultra thin film insulated transformer windings with a cross-section shaped as a parallelogram.

5. The apparatus of claim 1 further comprising a housing into which at least one spring and circuit are placed.

6. The apparatus of claim 1 wherein the D2 burner has a standard P32d base.

7. The apparatus of claim 1 wherein the D2 burner is press fit to an input spring and a return spring.

8. The apparatus of claim 1 further comprising a housing.

9. The apparatus of claim 8 wherein the interior of the housing is filled with epoxy and evacuated of substantially all air.

10. The apparatus of claim 1 further comprising a connector to couple the circuit board to a power supply.

11. A lamp assembly comprising:
a circuit board;
a transformer coupled to the circuit board wherein the transformer has a rectangular cross-section, and
wherein the circuit board and transformer are components in a high intensity discharge lamp.

12 The assembly of claim 11 wherein the transformer can produce between 12,000 and 30,000 volts.

13. The assembly of claim 11 wherein the transformer is comprised of ultra thin film insulation.

14. The assembly of claim 11 wherein the transformer is a high voltage, zinc nickel sinter powder ferrite core transformer.

15. A high intensity discharge light comprising
a burner coupled by at least one spring to an igniter assembly.

16. The light of claim 15 wherein the spring is sized to expand to fit a P32d nipple.

17. The light of claim 15 further comprising a transformer.

18. The light of claim 15 wherein the spring is insulated.

19. The light of claim 15 wherein the spring is placed in potting material to reduce vibrational energy and reduce sparking.

20. The light of claim 15 wherein the spring is press fitted to the base of a bulb and secured thereto.
